(19) United States
(12) Patent Application Publication
(10) Pub. No.: US 2006/0054702 A1
(43) Pub. Date: Mar. 16, 2006

(54) Method,System and Program to Record Sound to Photograph and to Play Back

(76) Inventor: Tianmo Lei, Santa Clara, CA (US)

Correspondence Address: TIANMO LEI, 814 BETLIN AVENUE, CUPERTINO, CA, 95014, US

(21) Appl. No.: 10/711,357

(22) Filed: Sep. 14, 2004

(51) Int. Cl. G06K 7/10

(52) U.S. Cl. 235/462.13; 235/462.1

(57) ABSTRACT

Method, system, and program to record sound to a photograph and to play back are disclosed. By creating a 2-dimensional barcode of sound and printing the barcode onto a photograph, the sound can be permanently recorded on the photograph and be play back. This procedure can be easily implemented with low cost. The 2-dimensional barcode is printed on the either side or the back of the photograph during printing the photograph or after. Using an ordinary optical scanner, or a digital camera, or a handhold 2-dimensional barcode reader, user can read back the 2-dimensional barcode on the photograph and decodes 2-dimensional barcode and finally recover the sound. Thus, when the users look at the photograph, users can hear the voice, speech or song of the person on the photograph, or the surrounding sound when the picture was taken, or other types of sound such as music etc.

### FIELD OF THE INVENTION

The personal and commercial talking photographs and pictures.

### BACKGROUND OF THE INVENTION

Technologies, which integrate sound and photograph together, were disclosed. [U.S. Pat. No. 5,520,544 Manico, et al.; U.S. Pat. No. 5,313,235 Inoue, et al.] But, all of them record the sound on somewhere else instead on the photograph itself, and do not use the 2-dimensional barcode.

The 2-dimensional barcode possesses a sufficient capacity to store information. QR barcode can record about 3000-byte message. Other types of barcode like MICRO PDF, SOFTSTRIP and DATACODE can store more information. The decode error rate of the PDF417 barcode can be low as to 10⁻⁷ and the barcode's error recover ability can be high as to that the lost information can be recovered even 49% PDF417 barcode is damaged.

By using sound data compression technology, 10000 bytes MWA format file can hold 5 seconds speech, 5000 bytes MIDI format music file can be played last to 5 minutes.

The microphone, various recorders and the Personal Computer provide the means for creating digital sound data; the printer, the optical scanner, digital camera, the cellular phone with embedded camera and the Personal Computer provide the means for recording and read back the 2-dimensional barcode onto and from a photograph or picture.

### SUMMARY OF THE INVENTION

Using microphone, various recorders and Personal Computer, users can convert the sound into digital data, then by encoding, generate a 2-dimensional barcode of the sound data. Using ordinary printer, the 2-dimensional barcode of sound data can be printed onto a photograph or picture. Using the general optical scanner, or digital camera header, or the handhold 2-dimensional barcode reader, the 2-dimensional barcode can be read back into the Personal Computer from the photograph with the software which will decode the barcode.

Thus, with a Personal Computer, include the desktop PC, the laptop PC, the palm PC, the PDA, the cellular phone, the digital camera and any other computer, plus the sound recording device, printer, and optical scanner or digital camera header, the ordinary users can record and play back their voice or song or any sound to and from their photograph; or record and play back the music to and from a scenic picture or postcard; or record and play back their greeting speech to and from their greeting card.

### BRIEF DESCRIPTION OF THE DRAWINGS

FIG. 1 shows the 1-dimensional (left) and the 2-dimensional (right) barcode.

FIG. 2 shows the system to record and play back the sound to and from a photograph.

FIG. 3 shows method and software program modules to record and play back the sound to and from a photograph.

FIG. 4 are two embodiments of the system, which play back the sound from the photograph.

FIG. 5 is another embodiment of the system, which plays back the sound from the photograph.

### DETAILED DESCRIPTION OF THE INVENTION

FIG. 1 shows the typical patterns of picture of the 1-dimensional barcode and 2-dimensional QR barcode. The latter contains more data than former. Put multiple barcode together can record sound with much longer period.

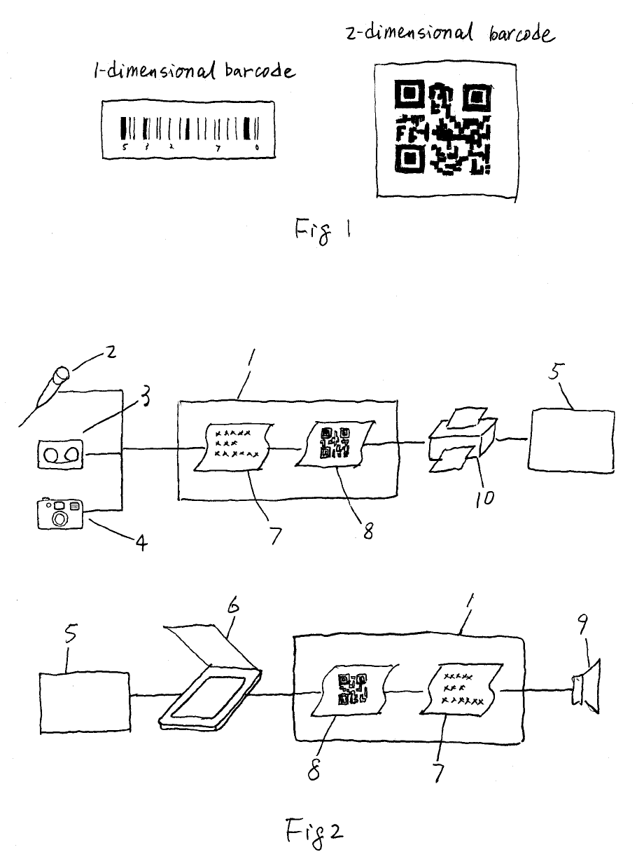

In the FIG. 2, the top half shows a record process. Using microphone 2, various recorder 3, digital camera 4, the Personal Computer 1 inputs the sounds and produces digital sound data 7. After compressing and encoding, the Personal Computer 1 produces a 2-dimensional barcode 8. Then, printer 10 prints this 2-dimensional barcode to photograph 5, which appear as a graphic picture. The bottom half of FIG. 2 shows the play back process. The optical scanner 6 scans the graphic picture on the photograph 5 as a 2-dimensional barcode 8. Personal Computer 1 recognizes and decodes the 2-dimensional barcode 8 to generate the digital sound data 7, finally plays the digital sound data 7 via the speaker 9.

Herein, the photograph 5 can also be any picture, postcard or greeting card. The Personal Computer 1 includes desktop, laptop, palm, PDA, cellular phone, digital camera or any other computer, which comprises a data processor like CPU, DSP, micro controller to process the 2-dimensional barcode and sound data, a memory like RAM, FLASH memory to store the program and the 2-dimensional barcode and sound data, a input port to enter the digital sound data, a output port to print the 2-dimensional barcode, a input port to scan the 2-dimensional barcode and a output port to play the sound. The optical scanner 6 includes also the digital camera, the digital camera header, or cellular phone with embedded camera and handhold barcode reader. The printer 10 can be any high-resolution ink jet or laser printer.

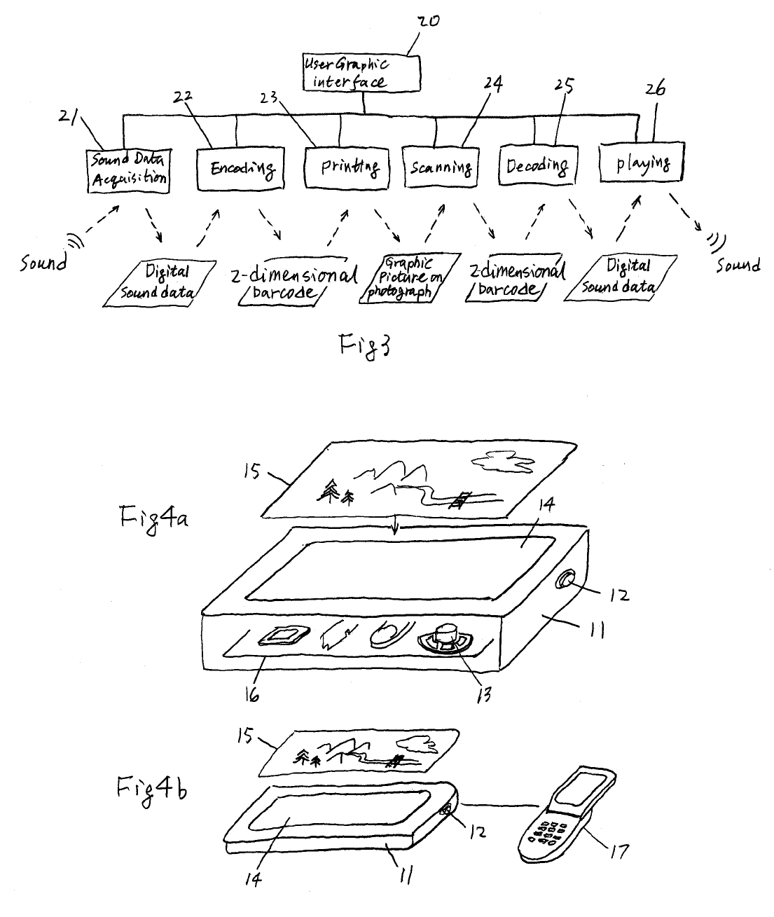

FIG. 3 shows the software program modules, which installed in a Personal Computer to record sound onto photograph and play back. The software program consists of a user friendly graphic interface 20; a data acquisition module 21 to interface with sound data acquisition device and produce digital sound data; a compressing and encoding module 22 to produce 2-dimensional barcode; a printing module 23 to print 2-dimensional barcode onto a photograph, which appear as a graphic picture; a scanning module 24 to control optical scanner to scan the photograph to obtain 2-dimensional barcode; a recognizing and decoding and uncompressing module 25 to generate digital sound data from the 2-dimensional barcode, and a playing module 26 to play the digital sound data.

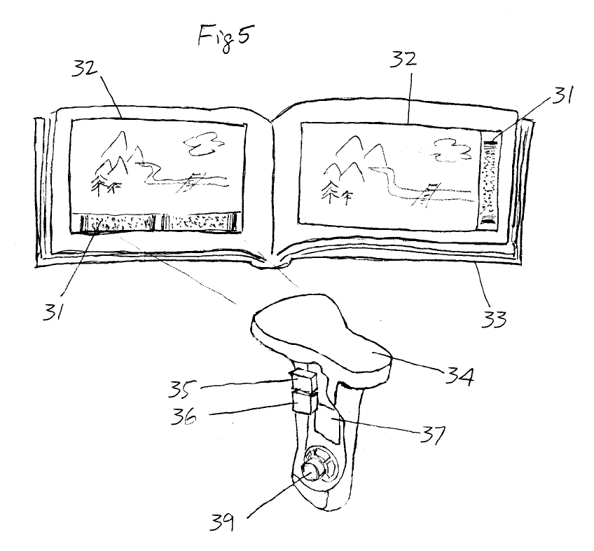

FIG. 4a is an embodiment of the system to scan a 2-dimensional barcode printed on a photograph and to play back the sound. A small-embedded computer 16 is integrated into a small CCD optical scanner 11. A photograph 15 is laid on the top 14 of the scanner. By pressing the play button 12, the small embedded computer controls the scanner to scan the 2-dimensional barcode printed on back of the photograph, recognizes and decodes and uncompress the 2-dimensional barcode, generates the digital sound data and plays the data via the speaker 13. In the FIG. 4b, the small embedded computer is removed from the scanner 11, a cellular phone 17, or a palm PC, or a PDA, or a laptop PC, or a desktop PC is connected to the scanner 111 to control the scanner and to play the sound. The small scanner also can be any digital camera header to shoot the 2-dimensional barcode symbol.

FIG. 5 shows the method using handhold barcode reader 34 to reproduce the sound from the photograph 32. By pressing the scan button 35, the small embedded computer 37 controls a infrared emission-receiver to read in the 2-dimensional barcode 31 on the side of the photograph 32, recognizes and decodes and uncompress the 2-dimensional barcode, generates the digital sound data. By pressing the play button 36, the Small embedded Computer 37 plays the digital sound data using a small speaker 39.

Except using the handhold barcode reader, users can use the camera embedded in any cellular phone to shoot the 2-dimensional barcode on the photograph; a program running in the cellular phone can process the 2-dimensional barcode and play back the sound. Or, users can use any digital camera to shoot the 2-dimensional barcode on the photograph; a program running in the digital camera can process the 2-dimensional barcode and play back the sound.

1. A system to record sound to photograph and to play back comprises:
(a) Means for recording and digitizing the said sound to produce a digital sound data using microphone and various recorders;
(b) Means for entering the said digital sound data into a Personal Computer;
(c) Means for compressing and encoding the said digital sound data into a 2-dimensional barcode using the said Personal Computer;
(d) Means for printing the said 2-dimensional barcode on to the side of the said photograph, which appears as a graphic picture, using the said Personal Computer and a printer;
(e) Means for printing the said 2-dimensional barcode on to the back of the said photograph, which appears as a graphic picture, using the said Personal Computer and a printer;
(f) Means for scanning the said graphic picture to produce digital data representing the information of the said 2-dimensional barcode, using the said Personal Computer and a scanner;
(g) Means for decoding and uncompressing the said digital data of the said 2-dimensional barcode to produce the said digital sound data, using the said Personal Computer;
(h) Means for playing the said digital sound data to sound, using the said Personal Computer and a speaker.

2. A method and a program to recording sound to photograph and to play back, running in a Personal Computer, comprises:
(a) An acquisition module to control sound acquisition device for recording the said sound to produce digital sound data;
(b) A compressing and encoding module to encode the said digital sound data into a 2-dimensional barcode;
(c) A printing module to print the said 2-dimensional barcode on to the back of the said photograph, which appears as a graphic picture;
(d) A printing module to print the said 2-dimensional barcode on to the side of the said photograph, which appears as a graphic picture;
(e) A scanning module to scan the said graphic picture on the said photograph to produce digital data representing the information of the said 2-dimensional barcode;
(f) A decoding and uncompressing module to recognize and decode and uncompress the said digital data of the said 2-dimensional barcode to produce the said digital sound data;
(g) A playing module to play the said digital sound data to the said sound.

3. A system to play back the a sound from the a 2-dimensional barcode printed on a photograph comprises:
A cellular phone which have an embedded camera, be used to shoot the said 2-dimensional barcode printed on the said photograph;
A decoding program and the a playing program, running in the said cellular phone to decode the said 2-dimensional barcode and play back the said sound encoded in the said 2-dimensional barcode.

4. A system to play back the a sound from the a 2-dimensional barcode printed on a photograph comprises:
A digital camera which be used to shoot the said 2-dimensional barcode printed on the said photograph;
A decoding program and the a playing program, running in the said digital camera to decode the said 2-dimensional barcode and play back the said sound encoded in the said 2-dimensional barcode.
